(19) United States
(12) Patent Application Publication
(10) Pub. No.: US 2011/0003220 A1
(43) Pub. Date: Jan. 6, 2011

(54) METHOD AND APPARATUS FOR THE DISCONNECTION OF A FUEL CELL

(75) Inventors: Christian Riffelsberger, Thalheim/Wels (AT); Thomas Schmitsberger, Lambach (AT); Simon Wolfsegger, Pregarten (AT)

Correspondence Address: COLLARD & ROE, P.C., 1077 NORTHERN BOULEVARD, ROSLYN, NY, 11576, US

(73) Assignee: FRONIUS INTERNATIONAL GMBH, Pettenbach (AT)

(21) Appl. No.: 12/735,894

(22) PCT Filed: Feb. 23, 2009
(86) PCT No.: PCT/AT2009/000072

§ 371 Date: Aug. 24, 2010

(30) Foreign Application Priority Data
Mar. 28, 2008 (AT) A 491/2008

(51) Int. Cl. H01M 8/04

(52) U.S. Cl. 429/429

(57) ABSTRACT

The invention relates to a method for the disconnection of a fuel cell (1) with a plurality of cells (11) connected in series, wherein at least two reaction gases are supplied during operation, and the supply of at least one reaction gas is interrupted after operation, and the reaction gas remaining at least in one of the cells (11) is consumed by the current generated by the reaction gases in the cell (11) being dissipated via at least one consumer (13), and to an apparatus for implementing the method. For the complete and controlled consumption of the reaction gases remaining in the individual cells (11), the invention provides that at least one consumer (13) is connected via at least one switching element (14) per cell (11) to each cell (11), with the result that the consumer (13) forms a dedicated circuit with each cell (11), and that at least one reaction gas of each individual cell (11) is completely consumed by the current generated by the reaction gases in the cell (11) being dissipated via the at least one consumer (13) connected to the cell (11).

The invention relates to a method for shutting down a fuel cell including several cells connected in series, wherein at least two reaction gases are supplied during operation and the supply of at least one reaction gas is interrupted after operation, and wherein the reaction gas remaining in at least one of the cells is consumed by the current generated in the cell by the reaction gases being dissipated via at least one consumer.

Likewise, the invention relates to a device for shutting down a fuel cell including several cells connected in series and connections for supplying at least two reaction gases, comprising at least one consumer for dissipating the current generated by the reaction gas present in each cell after operation.

From DE 100 59 393 A1 it is known to remove, after the operation of a fuel cell, residues of the reaction gases which generate the electric current by a chemical reaction. This is effected by an electric resistor which is connected in parallel with the fuel cell.

DE 10 2004 034 071 A1 relates to a switching-off procedure for fuel cell systems as may, for instance, be used in electrically driven vehicles. When shutting down the fuel cell system, the supply of a reaction gas, i.e. the supply of hydrogen, is interrupted and the remaining residual gas is supplied to an electric consumer.

U.S. Pat. No. 5,105,142 A1 describes a discharging circuit for a fuel cell, wherein, after the shutdown of the fuel cell, the current generated by the residual gas is dissipated via a parallel resistor, which may also be variable.

This involves the drawback that, in the event of a non-uniform distribution of the residual gases in the individual cells of the fuel cell, the residual gases are consumed differently rapidly. As a result, a current will continue to flow through the cells until all of the residual gases will have been consumed. Consequently, current will also flow through cells whose residual gases have already been consumed. This will cause the voltage on those gas-depleted cells to be inverted, which may in turn cause significant damage to those local cells. As a further result, the efficiency and service life of the fuel cell will deteriorate accordingly.

The object of the present invention, therefore, consists in the complete and controlled consumption of the reaction gases remaining in the individual cells after the shutdown of the fuel cell.

The object of the invention in method terms is achieved in that at least one consumer is connected with each cell via at least one switching element per cell such that the consumer forms a separate circuit with each cell, and that at least one reaction gas of each individual cell is completely consumed by the current generated in the cell by the reaction gases being dissipated via the at least one consumer connected to the cell. This offers the advantage that the reaction gases remaining in each cell are consumed in a controlled manner, while the rest of the cells of the fuel cell will not be loaded. A cell-damaging voltage inversion will thereby be reliably prevented. Likewise, the shutdown procedure of the fuel cell can thereby be accelerated. What is decisive here is that each individual cell of the fuel cell forms a separate circuit with a consumer, via which circuit the remaining reaction gases of the individual cell can be consumed without affecting the other cells.

By the measure that at least one consumer is connected to each cell so as to form a separate circuit with each individual cell, the rapid and safe consumption of the reaction gases of each cell will be ensured.

In an advantageous manner, a consumer is connected to each cell stepwisely one after the other. This enables a simple and cost-effective execution of the method.

If a consumer is connected to each cell via at least one switching element per cell, it will be ensured that the fuel cell will not be loaded by the consumer(s) during operation.

By the measure that the switching elements are controlled by a control device, the rapid and automatic execution of the method will be feasible.

It will also be advantageous, if the voltage of each cell is measured. This will enable the execution of the method while taking into account the measured cell voltages.

In an advantageous manner, the at least one consumer is disconnected during the measurement of the cell voltage so as to not influence said measurement.

According to a further characteristic feature of the invention, it is provided that a consumer is connected to the respective cell stepwisely as a function of the measured cell voltage. This enables a particularly efficient shutdown of the fuel cell in that, for instance, the reaction gas of the cell with the highest cell voltage is consumed first, and after this the cell having the next-highest cell voltage is connected to the consumer. The device for measuring the cell voltage can also be used during the operation of the fuel cell for measuring the cell voltages. Advantageously, a measuring device is provided, which can be connected to the cells by the same switching elements via which the consumer is connected to the cells. This will provide a cost-effective assembly.

The object of the invention is, however, also achieved by an above-mentioned device in which the at least one consumer is connectible with each individual cell via at least one switching element each so as to enable the dissipation of the current generated by the reaction gas present in each cell after operation via said consumer.

In an advantageous manner, a consumer is connectible with each individual cell via two manifolds and the at least one switching element each. This will provide a very efficient, simple and cost-effective assembly.

The switching elements are advantageously connected with a control device. The shutdown procedure can thus be accordingly automated, and the consumer can be disconnected during the operation of the fuel cell such that the fuel cell will not be loaded by the consumer.

The control device is advantageously configured for the stepwise connection of a consumer to each cell. This enables a single consumer to be used for all cells (e.g. 100) of a fuel cell stack.

If the consumer is arranged between the manifolds via a switching element, it can, for instance, be disconnected during the operation of the fuel cell.

In an advantageous manner, a device for measuring the voltage of the cells is provided.

Said measuring device can be connected in parallel with the consumer via the manifolds.

If the measuring device is connected with the control device and the control device is configured to control the switching elements of each cell as a function of the measured cell voltage, the consumer and/or the measuring device can be step-wisely connected to each individual cell, thus ensuring a particularly efficient and rapid execution of the shutdown of the fuel cell.

The consumer is advantageously formed by a transistor in linear operation. This enables the constant dissipation of the current generated in the cells by the consumption of the reaction gases and an acceleration of the shutdown of the cell or fuel cell, respectively.

The invention will be explained in more detail by way of the schematic drawings hereto attached. Therein:

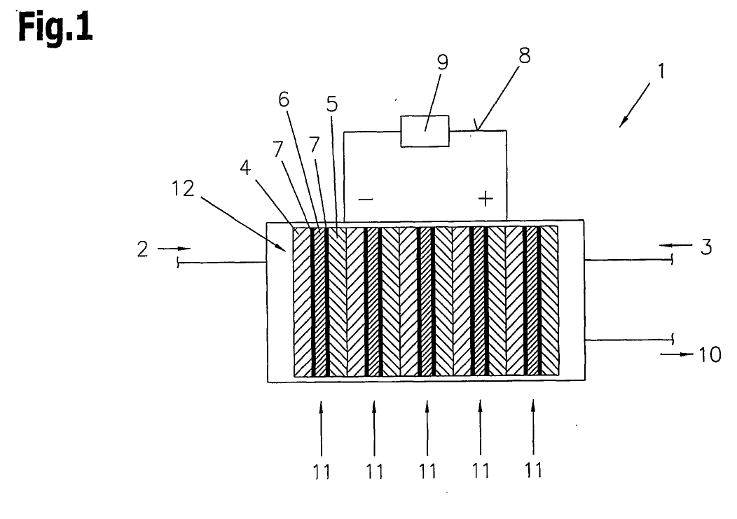

FIG. 1 illustrates the schematic structure of a fuel cell;

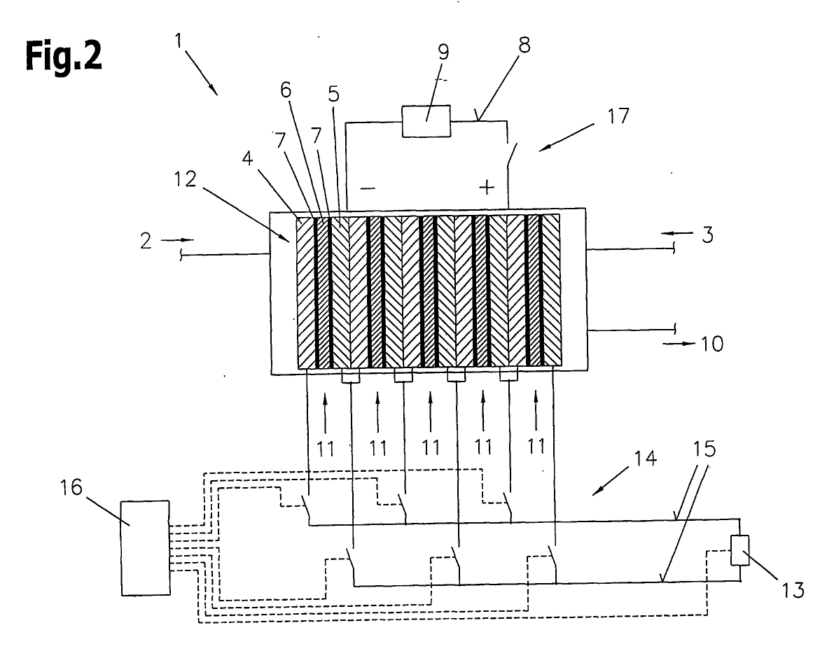

FIG. 2 is a schematic illustration of the device according to the invention for shutting down a fuel cell; and

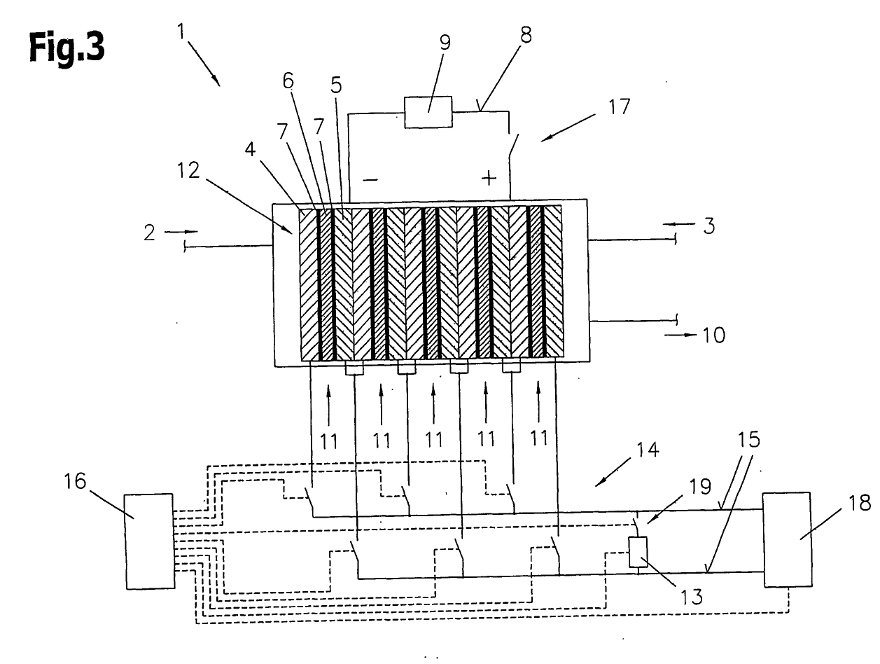

FIG. 3 is a schematic illustration of the device according to the invention for carrying out the method of the invention in a further embodiment.

To begin with, it is pointed out that identical parts of the exemplary embodiment bear the same reference numerals.

FIG. 1 depicts a fuel cell 1 for the generation of current from at least two reaction gases, advantageously hydrogen 2 and oxygen 3 or air.

In general, fuel cells 1 are electrochemical generators which generate current directly from a chemical compound. This is effected by the inversion of the electrolytic decomposition of water, during which the reaction gases hydrogen 2 and oxygen 3 are formed by a current flow.

The fuel cell 1 is composed of several cells connected in series, which are referred to as a stack 12. In a cell 11 of the fuel cell 1, the reaction gases hydrogen 2 and oxygen 3 thus mutually react to produce electric current. A cell 11 is formed by an anode 4, a cathode 5, an electrolyte 6 and a catalyst 7.

In the fuel cell 1, hydrogen 2 reacts with oxygen 3 to produce electric current. To this end, hydrogen 2 is supplied at an anode 4 and oxygen 3 is supplied at a cathode 5, the anode 4 and the cathode 5 being separated by an electrolyte 6. Furthermore, the anode 4 and the cathode 5 are coated with a catalyst 7, usually made of platinum, on their sides facing the electrolyte 6. This enables the hydrogen 2 to react with the oxygen 3, which takes place in two separate, single reactions on the two electrodes, i.e. the anode 4 and the cathode 5.

Hydrogen 2 is supplied at the anode 4, said hydrogen 2 reacting on the catalyst 7 with one hydrogen molecule being each cleaved into two hydrogen atoms. A hydrogen atom has two components, a negatively charged electron and a positively charged proton, each hydrogen atom liberating its electron. The positively charged protons diffuse to the cathode 5 through the electrolyte 6, which is impermeable to the negatively charged electrons.

Simultaneously with the supply of hydrogen 2 at the anode 4, oxygen 3 is supplied at the cathode 5. The oxygen molecules react on the catalyst 7 and are each cleaved into two oxygen atoms, which deposit on the cathode 5.

Thus, the positively charged protons of the hydrogen 2 as well as the oxygen atoms are deposited on the cathode 5, while the negatively charged electrons of the hydrogen 2 are deposited on the anode 4. This causes a so-called electron deficiency on the cathode 5 and a so-called electron excess at the anode 4. Hence results that the anode 4 is at a negative potential relative to the cathode 5, the anode 4 thus corresponding to a minus pole (−) and the cathode 5 to a plus pole (+).

If the two electrodes, i.e. the anode 4 and the cathode 5, are connected with an electric conductor 8, the electrons will travel from the anode 4 to the cathode 5 via the conductor 8 because of the potential difference. Direct current will thus flow through the line 8, and a load 9 connected therewith. The load 9 may, for instance, be comprised of a battery, which stores the produced current, or an inverter, which converts the produced direct current into an alternating current.

Two electrons that have traveled from the anode 4 to the cathode 5 via the conductor 8 are each absorbed by an oxygen atom in the cathode 5, thus becoming doubly negatively charged oxygen ions. These oxygen ions unite with the positively charged protons of the hydrogen 2, which have diffused from the anode 4 to the cathode 5 through the electrolyte 6, to form water 10. The water 10 is discharged from the cathode 5 as a so-called reaction end product.

For shutting down the fuel cell 1, the supply of the reaction gas oxygen 3, or air, is preferably interrupted. This causes at least a portion of the reaction gases to remain in the cells 11. Without any further measure, this would result in hydrogen 2 diffusing through the electrolyte 6 and causing the formation of an explosive mixture in the cathode 5 of the cells 11 at least with some types of fuel cells 1. The service lives of the cells 11 and, in particular, the electrolyte 6 and the catalyst 7, will also be strongly reduced. In order to prevent this, selective methods for shutting down the fuel cell 1 have been employed. The portion of oxygen 3 in the reaction gas will thus be consumed to such an extent as to enable the shutdown of the fuel cell 1 in the switched-off state without any risk. Since such methods are basically known from the prior art, only the details according to the invention will be discussed below.

The method for shutting down the fuel cell 1 according to the invention is executed in a manner that at least one reaction gas of each individual cell 11 is completely consumed by the current generated in the cell 11 by the reaction gases being dissipated via at least one consumer 13 separately connected to each of the cells 11. As opposed to the provision of a resistor common to all of the cells 11, no voltage inversion jeopardizing the cells 11 will occur in the event of a premature local gas depletion. The consumption of the reaction gases in the cells 11 of the fuel cell 1 is also referred to as an abreaction of the cells 11.

FIG. 2 schematically illustrates a device according to the invention for carrying out the method of the invention.

From this, it is apparent that the at least one consumer 13 is connectible to each cell 11 of the stack 12, preferably via two switching elements 14 each. This is effected in that the consumer 13 is connected in parallel with the cell 11 and forms a circuit with the same, which is closed via the switching elements 14. In order to enable this separately for all of the cells 11 of the stack 12, each pole of a cell 11 is each connected with one of the manifolds 15 via one of the switching elements 14. In doing so, two neighboring poles of two cells 11 are connected with one of the manifolds 15 via one of the switching elements 14. The consumer 13 is arranged between the manifolds 15 so as to be connectible with each cell 11 of the stack 12. Thus, a consumer 13 can be connected to each cell 11 of the stack 12 consecutively, or stepwisely one after the other, via the switching elements 14 in order to completely consume the reaction gases of each cell 11. When the reaction gases, in particular the oxygen 3, are completely consumed in the cell 11 connected with the consumer 13, the consumer 13 is connected to the following cell 11. The switching elements 14 preferably are accordingly controlled by a control device 16 in such a manner that only one cell 11 will each be loaded by the consumer 13. The control device 16 also performs the switching of the consumer 13 from one cell 11 to the next.

The consumer 13 may be comprised of a variable resistor, a transistor in linear operation or the like, by which a constant current flow of sufficient extent will be safeguarded until the complete consumption of the reaction gases. The resistance value of the consumer 13 can be accordingly controlled by the control device 16 such that the optimum value will always be adjusted.

In a preferred manner, the load 9, which is supplied with power during the operation of the fuel cell 1, is disconnected by a switch 17 during the method according to the invention. This will ensure that only the cell 11 with the connected consumer 13 will form a circuit during the consumption of the reaction gases.

FIG. 3 depicts a further variant embodiment of the method according to the invention.

In this variant, a measuring device 18 is additionally connected to the manifolds 15 for the detection of the voltages of the individual cells 11. To this end, the switching elements 14 which are responsible for the appropriate connection of the consumer 13 as described above are suitably used. During the voltage measurements, the consumer 13 is, however, preferably separated from the manifolds 15 by a switching element 19 so as to ensure precise voltage measurements. To this end, a data exchange between the measuring device 18 and the control device 16 via a suitable data line is of advantage.

With such a measuring device 18, the method for shutting down a fuel cell 1 is preferably performed in several steps. At first, after the shutdown of the fuel cell 1, the voltage of each individual cell 11 is consecutively or stepwisely measured with the consumer 13 disconnected, and accordingly stored. In the next step, the stored voltage values of the cells 11 are sorted in descending order. This causes the cell 11 with the highest voltage value to be completely abreacted first in the subsequent step. To this end, the consumer 13, by the switching element 19, and the respective cell 11, by the switching elements 14, are connected with the manifolds 15 so as to form a closed circuit. After this, the cell 11 with the second-highest voltage value is abreacted in the subsequent step. This is continued until the abreaction of the cell 11 with the lowest voltage has been completed. In doing so, the consumer 13 will, however, preferably remain connected between the manifolds 15 such that only the respective cell 11 will be connected to the manifolds 15 by the switching elements 14. In the following, all of the cells 11 of the stack 12 are thus connected to the consumer 13 by the control device 16 one after the other, or stepwisely, according to the stored order. This means that the cells 11 having most of the reaction gases, and hence the highest voltages values, are abreacted first. The risk of damage to the cells 11 will thus be kept extremely low.

Since the measuring device 18 is likewise connected to the manifolds 15, it is consequently connected in parallel with the consumer 13. This will advantageously ensure that the voltage will be constantly measured during the abreaction of the cell 11. Hence results that the resistance value of the consumer 13 can be accordingly adapted to the measured voltage so as to safeguard a substantially constant current flow until the complete consumption of the oxygen 3. Correspondingly, this current flow will automatically stop again after the consumption of the reaction gases.

The manifolds 15 with the switching elements 14 connected thereto thus have to fulfil at least two functions according to the invention. On the one hand, ensure that the only consumer 13 is separately connectible with each cell 11 of the stack 12. On the other hand, enable the measurement of the voltage of each cell 11 using the measuring device 18 connected to the manifolds 15. The thus resulting measured value can be used to monitor the cell voltage during operation, on the one hand, and to control the consumer 13 during the shutdown of the stack 12, or fuel cell 1, on the other hand. To this end, the voltage of the cells 11 is taken into account when abreacting the cells 11.

To sum up, it can be said that, for the abreaction of a cell 11, the latter is each connected with one of the manifolds 15 by a switching element 14 so as to form a closed circuit with the consumer 13. In addition, the voltage of each cell 11 is measured or monitored during the abreaction such that each cell 11 is advantageously controlled and gently abreacted. It is also of advantage that the overall time for abreacting the stack 12 will be shortened, since each cell 11 is extremely efficiently abreacted.

It should finally be mentioned that, in general, the invention can also be used with an interconnection of several fuel cells 1, wherein, in the simplest case, merely one consumer 13 and optionally a measuring device 18 are required for performing the method according to the invention.

1-16. (canceled)

17. A method for shutting down a fuel-cell stack (12) including several cells (11) connected in series, wherein at least two reaction gases are supplied during operation and the supply of at least one reaction gas is interrupted after operation, and wherein the reaction gas remaining in at least one of the cells (11) is consumed by the current generated in the cell (11) by the reaction gases being dissipated via at least one consumer (13), and wherein the voltage of each cell (11) is measured, wherein the at least one consumer (13) is connected with each cell (11) via manifolds (15) and each by at least one switching element (14) per cell (11) such that the at least one consumer (13) forms a separate circuit with each cell (11), and the at least one consumer (13) is stepwisely connected as a function of the measured voltage of each cell (11), and wherein at least one reaction gas of each individual cell (11) is completely consumed by the current generated in the cell (11) by the reaction gases being dissipated via the at least one consumer (13) connected to the cell (11).

18. A method according to claim 17, wherein the switching elements (14) are controlled by a control device (16).

19. A method according to claim 17, wherein the at least one consumer (3) is disconnected during the measurement of the cell voltage.

20. A device for shutting down a fuel-cell stack (12) including several cells (11) connected in series and connections for supplying at least two reaction gases, comprising at least one consumer (13) for dissipating the current generated by the reaction gas present in each cell (11) after operation, wherein a device (18) for measuring the voltage of the cells (11) is provided, wherein the at least one consumer (13) is connectible with each individual cell (11) via two manifolds (15) and at least one switching element (14) each so as to enable the dissipation of the current generated by the reaction gas remaining in each cell (11) after operation via said at least one consumer (13), and wherein, furthermore, the switching elements (14) are connected with a control device (16) connected with the measuring device (18), and the control device (16) is configured to control the switching elements (14) of each cell (11) for the stepwise connection of the cells (11) as a function of the measured cell voltage.

21. A device according to claim 20, wherein the consumer (13) is arranged between the manifolds (15) via a switching element (19).

22. A device according to claim 20, wherein the measuring device (18) is connected in parallel with the consumer (13) via the manifolds (15).

23. A device according to claim 20, wherein the at least one consumer (13) is formed by a transistor in linear operation.
